(19) United States
(12) Patent Application Publication
(10) Pub. No.: US 2025/0187400 A1
(43) Pub. Date: Jun. 12, 2025

(54) METHOD OF PROVIDING HEATING POWER INFORMATION TO DRIVER OF VEHICLE AND SYSTEM ADOPTING THE SAME

(71) Applicants: Hyundai Motor Company, Seoul (KR); Kia Corporation, Seoul (KR)

(72) Inventor: Bo-Hyeon RYU, Whasung-Si (KR)

(73) Assignees: Hyundai Motor Company, Seoul (KR); Kia Corporation, Seoul (KR)

(21) Appl. No.: 18/805,831

(22) Filed: Aug. 15, 2024

(30) Foreign Application Priority Data
Dec. 6, 2023 (KR) 10-2023-0175278

(51) Int. Cl. B60H 1/00

(52) U.S. Cl. CPC B60H 1/00985; B60H 1/00371

(57) ABSTRACT

A method of providing heating power information to a driver includes executing, by a control unit of the vehicle, a heating mode according to a driver's input command, collecting, by the control unit, power consumption-related information according to the heating mode, transmitting, by the control unit, the power consumption-related information to a management server, and generating, by the management server, energy efficiency information indicating maximum savable power consumption using the power consumption-related information and feedbacking the energy efficiency information to the control unit of the vehicle.

### CROSS-REFERENCE TO RELATED APPLICATION

The present application claims priority to Korean Patent Application No. 10-2023-0175278, filed on Dec. 6, 2023, the entire contents of which is incorporated herein for all purposes by this reference.

### BACKGROUND OF THE PRESENT DISCLOSURE

### Field of the Present Disclosure

The present disclosure relates to a heating power information technology for a vehicle, and more specifically, to a method and a system of providing heating power information to a driver of a vehicle on a heating system operated in an electrified vehicle in winter.

### Description of Related Art

In addition to a function as a transporting means for a driver and passengers, vehicles are developed to increase the safety of passengers while moving and provide comfort to maintain the conditions and moods of the passengers having the driver in the best condition during a traveling time.

Various technological devices are applied to vehicles, which may not only operate in a good environment, but also operate normally in any unfavorable environments and provide passengers with a comfortable feeling even in bad weather or low or high temperature environments outside thereof.

For example, in a cold season such as winter, heaters are operated to increase an internal temperature of the vehicle. In particular, water heaters are generally applied to electrified large vehicles (e.g., electric buses) for indoor heating. Since such type of heating device using the water heater has low energy efficiency, a highly energy-efficient heat pump system is applied to improve energy efficiency in winter by reducing an operation duty of the heating device.

A heating system for a vehicle generally includes a water heater mounted on an internal floor of the vehicle as a main heater and a heat pump mounted on a roof of the vehicle as an auxiliary heater.

However, such a heating system has a disadvantage of a low heating efficiency to the driver, making it difficult for the driver to efficiently manage energy efficiency of the heating system.

Furthermore, such the heating system fails to guide the driver to use an auto mode for the heating system, resulting in a decrease in energy efficiency of the vehicle.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a method of providing heating power information to a driver for improving heating efficiency of a heating system of a vehicle.

Furthermore, the present disclosure is directed to providing a method of providing heating power information to a driver which is capable of guiding the driver to use an auto mode for the heating system.

To achieve the objects, the present disclosure provides a method of providing heating power information including steps of: executing, by a control unit of the vehicle, a heating mode to operate a water heater for indoor heating according to a driver's input command; collecting, by the control unit, power consumption-related information according to the heating mode; transmitting, by the control unit, the power consumption-related information to a management server communicatively connected to the control unit; and generating, by the management server, energy efficiency information indicating maximum savable power consumption using the power consumption-related information and feedbacking the energy efficiency information to the control unit of the vehicle.

Furthermore, the maximum savable power consumption may be a result of comparison between actual heating power consumption consumed while the vehicle travels actually and optimal use power consumption indicating a predicted power consumption value.

Furthermore, the optimal use power consumption may be determined only in case of using an auto mode in which at least one of one or more water heaters disposed on an internal floor of the vehicle and a heat pump disposed on a roof of the vehicle is automatically turned on or off according to a preset algorithm.

Furthermore, the power consumption-related information may include actual heating power consumption indicating an actual power use value according to the heating mode, information indicating ON/OFF of the auto mode, and information indicating a manual mode in which the auto mode is not used.

Furthermore, the optimal use power consumption may be determined by applying a correction constant for power consumption conversion in response that the manual mode according to an average outside air temperature for actual days of use is changed to the auto mode and an auto duty ratio indicating an operation ratio of the auto mode upon actual heating operation to an actual use heating power.

Furthermore, the optimal use power consumption may be determined by summing a first value determined by multiplying the actual use heating power by the correction constant and a second value obtained by multiplying a value, which is obtained by multiplying the actual use heating power and the correction constant by the auto duty ratio, by the actual use heating power.

Furthermore, the auto duty ratio may be a value obtained by dividing an auto mode operation time by a sum of the auto mode operation time indicating an operation time of the auto mode and a manual mode operation time indicating an operation time of the manual mode.

Furthermore, the auto mode operation time and the manual mode operation time may be each determined using a time for which a pre-predetermined value is input and maintained in a waveform extracted from the power consumption-related information.

Furthermore, the actual heating power consumption may be determined using an area of a quadrangle formed between an x-axis indicating a time and a y-axis indicating power consumption in a graph extracted from the power consumption-related information.

Furthermore, the actual heating power consumption may be the sum of the power consumption of the water heater determined by the area of the quadrangle and the power consumption of the heat pump.

Furthermore, in a state that operation buttons configured for operating the one or more water heaters and the heat pump installed in the vehicle are connected, the heat pump may be operated by being connected automatically in response that the one or more water heaters are operated in the heating mode.

Furthermore, the power consumption-related information may be a form of an in-vehicle communication message.

Furthermore, the feedback may output the energy efficiency information on a display unit in combination of texts, voices, and graphics.

On the other hand, another exemplary embodiment of the present disclosure may provide a method of providing heating power information of a vehicle including steps of executing, by a control unit of the vehicle, a heating mode to operate a water heater for indoor heating according to a driver's input command; collecting, by the control unit, power consumption-related information according to the heating mode; transmitting, by the control unit, the power consumption-related information to a management server communicatively connected to the control unit; and generating, by the management server, energy efficiency information indicating a maximum savable power consumption using the power consumption-related information and feedbacking the energy efficiency information to the control unit of the vehicle, wherein the executing of the heating mode may include, in a state that operation buttons configured for operating the one or more water heaters and the heat pump installed in the vehicle are configured separately, providing, by the control unit, a guidance message which allows the heat pump to operate together in response that the one or more water heaters is operated in the heating mode.

Various exemplary embodiments of the present disclosure may provide a system of providing heating power information to a driver of a vehicle, the system including: a heating system including a control unit for controlling a heating mode to operate a water heater block, the water heater block for heating a passenger compartment of the vehicle, a main driving unit operatively connected to the water heater block for operating the water heater block, a heat pump mounted on a roof of the vehicle, a pump driving unit operatively connected to the heat pump for operating the heat pump, and an air conditioner for controlling temperature, humidity and cleanliness of air in the passenger compartment of the vehicle, wherein the control unit is configured to: execute the heating mode according to a driver's input command; collect power consumption-related information according to the heating mode; transmit the power consumption-related information to a management server communicatively connected to the control unit; and generate, by the management server, energy efficiency information indicating maximum savable power consumption using the power consumption-related information and feedbacking the energy efficiency information to the control unit of the vehicle.

In the system, the optimal use power consumption may be determined only in case of using an auto mode in which at least one of one or more water heaters disposed on an internal floor of the vehicle and a heat pump disposed on a roof of the vehicle is automatically turned on or off according to a preset algorithm.

In the system, the power consumption-related information may include actual heating power consumption indicating an actual power use value according to the heating mode, information indicating ON/OFF of the auto mode, and information indicating a manual mode in which the auto mode is not used.

In the system, the optimal use power consumption may be determined by applying a correction constant for power consumption conversion when the manual mode according to an average outside air temperature for actual days of use is changed to the auto mode and an auto duty ratio indicating an operation ratio of the auto mode upon actual heating operation to an actual use heating power.

In the system, the optimal use power consumption may be determined by summing a first value determined by multiplying the actual use heating power by the correction constant and a second value obtained by multiplying a value, which is obtained by multiplying the actual use heating power and the correction constant by the auto duty ratio, by the actual use heating power.

In the system, the actual heating power consumption may be determined using an area of a quadrangle formed on an x-axis indicating a time and a y-axis indicating power consumption in a graph extracted from the power consumption-related information.

According to an exemplary embodiment of the present disclosure, by providing the heating efficiency of the heating system to the driver, it is possible to efficiently manage energy efficiency by the driver.

Furthermore, it is possible to guide the driver to use the auto mode for the heating system, increasing the energy efficiency of the vehicle.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram of a configuration of a heating system according to an exemplary embodiment of the present disclosure.

FIG. 2 is a block diagram of a detailed configuration of a system for providing heating power information according to an exemplary embodiment of the present disclosure.

FIG. 3 is a conceptual diagram of an air-conditioning system configured in a vehicle according to an exemplary embodiment of the present disclosure.

FIG. 4 is a flowchart showing a process of providing heating power information to a driver according to an exemplary embodiment of the present disclosure.

FIG. 5 is a graph showing a concept in which power consumption of a water heater is determined according to an exemplary embodiment of the present disclosure.

FIG. 6 is a graph showing a concept in which an auto duty ratio is determined according to an exemplary embodiment of the present disclosure.

FIG. 7 is a graph showing a concept in which an average outside temperature is determined according to an exemplary embodiment of the present disclosure.

FIG. 8 is an example of a display screen on which a charging cost by month of the vehicle is displayed according to an exemplary embodiment of the present disclosure.

FIG. 9 is an example of a display screen on which heating power consumption per day of the vehicle is displayed according to an exemplary embodiment of the present disclosure.

FIG. 10 is an example of a display screen on which simplified vendor management vehicle information is displayed according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The above-described objects, features, and advantages will be described below in detail with reference to the accompanying drawings, and thus those skilled in the art to which the present disclosure pertains will be able to easily carry out the technical spirit of the present disclosure. In describing the present disclosure, when it is determined that a detailed description of the known technology related to the present disclosure may unnecessarily obscure the gist of the present disclosure, a detailed description thereof will be omitted. Hereinafter, various exemplary embodiments according to an exemplary embodiment of the present disclosure will be described in detail with reference to the accompanying drawings. In the drawings, the same reference numerals are used to denote the same or similar components.

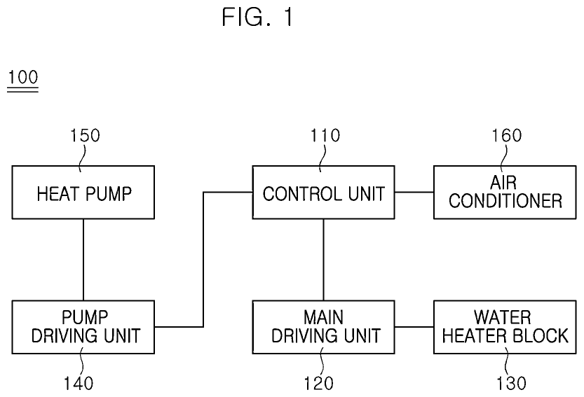

FIG. 1 is a block diagram of a configuration of a heating system 100 in a vehicle according to an exemplary embodiment of the present disclosure. Referring to FIG. 1, a heating system 100 may include a control unit 110, a main driving unit 120, a water heater block 130, a pump driving unit 140, a heat pump 150, an air conditioner 160, and the like.

The control unit 110 may perform a function of receiving a power consumption value of the heating system consumed while a vehicle travels actually as an in-vehicle communication message and determining an optimal use power consumption value based on the message information. To the present end, communication is connected between the control unit 110 and other components or between the control unit 110 and an upper level controller or a lower level controller. As a communication means, a multimedia-controller area network (MM-CAN), a body-controller area network (B-CAN), a high-speed Controller Area Network (CAN), a communication line (e.g., 500 kbps), a flexible data-rate (CAN-FD), a communication line, a Flexlay communication line, a Local Interconnect Network (LIN) communication line, a power line communication (PLC) communication line, a control pilot (CP) communication line, or the like may be configured.

The main driving unit 120 may transmit or receive signals to or from the control unit 110 and turn the water heater block 130 on or off by control signals of the control unit 110. To the present end, the main driving unit 120 may include a direct current-direct current (DC-DC) converter for supplying power to the water heater, a semiconductor chip for controlling an operation of the water heater, a switching element for turning power supply to the water heater on or off, and the like.

The water heater block 130 may be formed of a plurality of water heaters, and the water heaters may perform an internal heating of the vehicle. The water heater may be mounted on an internal floor of the vehicle as a main heater for heating. The water heater may heat cooling water using a heating element such as a high voltage heater.

The pump driving unit 140 may transmit or receive signals to or from the control unit 110 and turn the heat pump 150 on or off by control signals of the control unit 110. To the present end, the pump driving unit 140 may include a DC-DC converter for supplying power to the heat pump 150, the semiconductor chip for controlling the operation of the heat pump 150, the switching element for turning on or off the power supply to the heat pump 150, and the like.

The heat pump 150 may be mounted on a roof of the vehicle as an auxiliary heater. In general, the heat pump 150 may be constructed as a roof-on-mount type one unit heat pump which is discretely operated by the driver.

The air conditioner 160 may perform heating, ventilation, and air conditioning. The air conditioner 160 may perform a temperature control for heating and cooling air, a humidity control for humidifying and dehumidifying air, and further control an airflow speed, airflow distribution, and cleanliness of the air. To the present end, a body case in which an evaporator and a heater core are provided, and a blower case on which a blower is provided to blow air into the body case are provided.

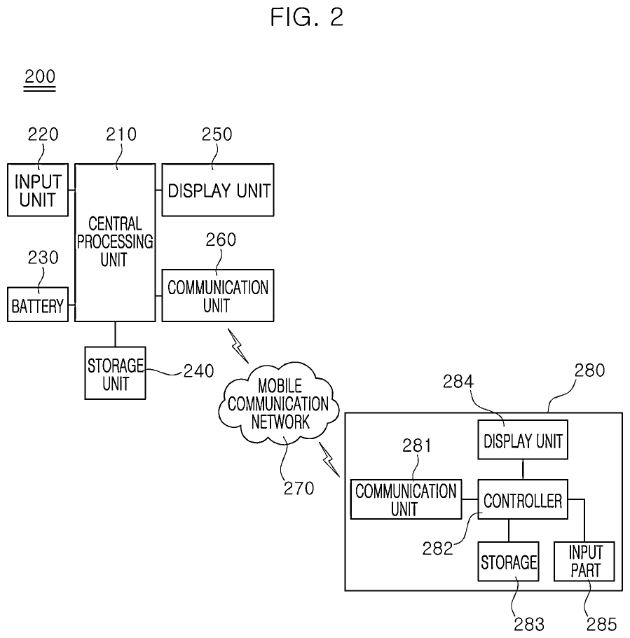

FIG. 2 is a block diagram of a detailed configuration of a system 200 for providing heating power information according to an exemplary embodiment of the present disclosure. Referring to FIG. 2, the system 200 may include a central processing unit 210, an input unit 220 for inputting a driver's command, a storage unit 240 for storing data, a communication unit 260 for communicating with internal components of the vehicle, and the like.

The central processing unit 210 may receive the power consumption value of the heating system consumed while the vehicle travels actually as an in-vehicle communication message and execute an algorithm for determining the optimal use power consumption value based on the message information. The central processing unit 210 may be a microprocessor, microcomputer, or the like.

The input unit 220 may be a touch screen, a microphone, a physically operated button, or the like.

The central processing unit 210 may be connected to the battery 230 to receive power. The battery 230 may also supply power to the main driving unit 120, the water heater block 130, the pump driving unit 140, the heat pump 150, the air conditioner 160, and the like, which are components.

The battery 230 may include battery cells configured in series and/or parallel, and the battery cells may be high-voltage battery cells for electric vehicles, such as nickel metal battery cells, lithium ion battery cells, lithium polymer battery cells, lithium sulfur battery cells, sodium sulfur battery cells, and all-solid-state battery cells. In general, a high-voltage battery indicates a battery used as a power source for moving electric vehicles and has a high voltage of 100 V or more. However, the present disclosure is not limited thereto, and low-voltage batteries are also possible.

The battery 230 may include a battery management system (BMS). The BMS is configured to optimize battery management to increase energy efficiency and extend lifetime. The BMS may monitor a voltage, current, and temperature of the battery in real time and generates battery state information. The battery state information may include state of charge (SOC), state of health (SOH), depth of discharging (DOD), state of function (SOF), and the like.

The storage unit 240 may perform functions to store software, programs, data, and the like executed by the central processing unit 210. To the present end, the storage unit 240 may be configured in combination of non-volatile memories, such as a solid state disk (SSD), a hard disk drive, a flash memory, an electrically erasable programmable read-only memory (EEPROM), a static RAM (SRAM), a ferro-electric RAM (FRAM), a phase-change RAM (PRAM), and a magnetic RAM (MRAM) and/or volatile memories, such as a dynamic random access memory (DRAM), a synchronous DRAM (SDRAM), and a double data rate-SDRAM (DDR-SDRAM).

Furthermore, the central processing unit 210 may be connected to the display unit 250 to provide energy efficiency information, various menu screens, settings screens, and the like to the driver. The display unit 250 may be a liquid crystal display (LCD), a light emitting diode (LED) display, an organic light-emitting diode (OLED) display, a touch screen, a flexible display, a head up display (HUD), or the like. The touch screen may be used not only as an output device but also as an input device.

The energy efficiency information may include information indicating the energy efficiency and may be expressed as a traveling distance (km) per 1 kWh with a unit of km/kWh.

The communication unit 260 may perform a function of supporting communication between in-vehicle components. Furthermore, the communication unit 260 may perform a function of transmitting information processed by the central processing unit 210 to the outside thereof. To the present end, the communication unit 260 may include a microprocessor, a communication modem, or the like.

Referring to FIG. 2, the system 200 for providing heating power information to the driver may include a management server 280 connected through a mobile communication network 270. The management server 280 may include a communication unit 281 connected to the mobile communication network 270, a controller 282 for determining and comparing actual heating power consumption and optimal use power consumption using data received from the communication unit 260 through the communication unit 281 and generating energy efficiency information, a display unit 284 for displaying the energy efficiency information, an input portion 285 for inputting as an administrator's command, and the like.

The mobile communication network 270 may perform a function of receiving data from the vehicle wirelessly or transmitting data to the vehicle wirelessly. Therefore, the mobile communication network 270 may indicate a connection structure which enables information exchange between nodes, such as a plurality of terminals and servers, and may include Code Division Multiple Access (CDMA), Wideband CDMA (WCDMA), Wireless Broadband (WiBro), WiFi, Digital Living Network Alliance (DLNA), Zigbee, Z-wave, a High Speed Downlink Packet Access (HSDPA) network, Bluetooth, radio frequency identification (RFID), infrared data association (IrDA), an ultra-wide band, a wireless USB, a Near Field Communication (NFC) network, a satellite broadcasting network, an analog broadcasting network, a digital multimedia broadcasting (DMB) network, and the like.

However, the present disclosure is not limited thereto, and the mobile communication network 270 may include a public switched telephone network (PSTN), a public switched data network (PSDN), an integrated services network (ISDN), a broadband ISDN (BISDN), a local area network (LAN), a metropolitan area network (MLAN), a wide LAN (WLAN), and the like. Alternatively, the mobile communication network 270 may be a combination of the wired communication networks and the wireless communication networks.

The communication unit 281 may include a communication modem, a microprocessor, a microcomputer, and the like.

The display unit 284 may include an LCD, a light-emitting diode (LED) display, an Organic Light-Emitting Diode (OLED) display, a touch screen, a flexible display, a cathode ray tube (CRT), a flexible display, a micro LED, a mini LED, or the like.

A storage 283 may be similar to the storage unit 240, and the input portion 285 may include a similar configuration to the input unit 220. Therefore, additional description thereof will be omitted.

Although FIG. 2 shows that the vehicle and the management server 280 in a ratio of 1:1, the vehicle and the management server 280 may be configured in a ratio of N:1 or N:N−1. Alternatively, a number of vehicles may be connected to one management server, and in such a manner, a number of management servers may be configured, and the management servers may be connected to one final management server.

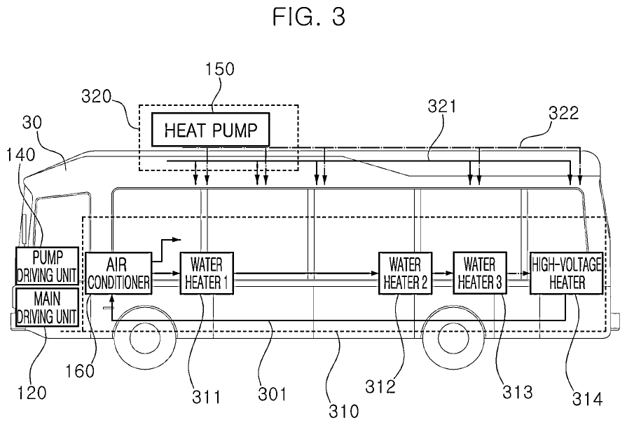

FIG. 3 is a conceptual diagram of an air-conditioning system configured in a vehicle according to an exemplary embodiment of the present disclosure. Referring to FIG. 3, a first heating supply chain 310 may be configured at a lower portion of the vehicle 30, and a second heating supply chain 320 may be configured at an upper portion of the vehicle 30.

The first heating supply chain 310 may include the air conditioner 160, a first water heater 311, a second water heater 312, a third water heater 313, and a high voltage heater 314. The hot water discharged from the air conditioner 160 may be heated by the first, second, and third water heaters 311 to 313 so that warm air may be discharged upward to a passenger compartment of the vehicle.

Hot water may flow along a flow path 301, may be heated by the high voltage heater 314, and may flow back into the air conditioner 160. The high voltage heater 314 may include an operating voltage range of about 100 V to 870 V. The high voltage heater 314 may mainly use a positive temperature coefficient (PTC) as a heating element.

The second heating supply chain 320 may be provided on the roof of the vehicle 30 and supply warm air 321 or cold air 322 downward the passenger compartment of the vehicle 30 by the heat pump 150.

Two types of operation buttons (i.e., a switch) may be configured for turning the first, second, and third water heaters 311, 312 and 313 and the heat pump 150 on or off.

1) In case that a water heater button and a heat pump button are separately provided, the heat pump button may need to be selected after the water heater button is selected. Therefore, in addition to a verbal warning, a guidance message to ask the driver to operate together with the heat pump because only the water heater is being operated may be provided on a driver display. Of course, at the instant time, a feedback based on the energy efficiency information in a form of a graph may be provided to the driver.

2) In case that the water heater button and the heat pump button are interconnected, the heat pump 150 may also be operated by being linked automatically when the water heater button is turned on as a main button. In other words, there is no need to operate the heat pump button separately or additionally.

The water heater button and the heat pump button may be physically configured on the input unit 220 and may be constructed as soft buttons displayed on the screen of the display unit 250 as icons.

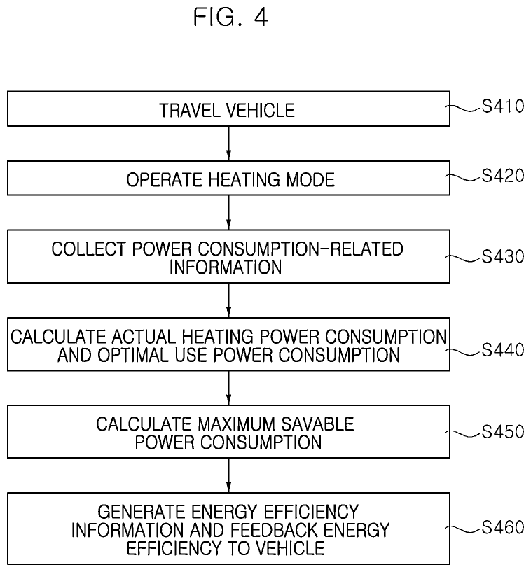

FIG. 4 is a flowchart showing a process of providing heating power information according to an exemplary embodiment of the present disclosure. Referring to FIG. 4, when the vehicle 30 travels and the driver generates an input command for heating operation via the input unit 220, the control unit 110 communicatively connected to the system 200 via the communication of the control unit 110 and the communication unit 260 of the system 200 may perform a heating mode to operate a water heater for indoor heating (S410 and S420).

Thereafter, the control unit 110 may collect power consumption-related information from the storage unit 240 and transmit the collected power consumption-related information to the management server 280 via the communication of the control unit 110 and the communication unit 281 of the management server 280 (S430). The power consumption-related information may include in-vehicle communication messages for determining actual heating power consumption, optimal operating power consumption, and the like. The in-vehicle communication messages may be messages exchanged for communication between in-vehicle components.

The controller 282 of the management server 280 may be configured to determine actual heating power consumption and optimal use power consumption using the power consumption-related information received from the control unit 110 of the vehicle 30 (S440).

The actual heating power consumption may be the sum of the water heater power consumption and the heat pump power consumption. In contrast, the optimal use power consumption may be a value which corrects the power consumption in an auto mode based on the actual heating power consumption. The auto mode may be a mode in which the water heaters 311 to 313 and the heat pump 150 are turned on or off according to a preset algorithm.

In other words, the preset algorithm may turn on the water heaters 311 to 313 and the heat pump 150 simultaneously or sequentially over time to maintain the ON state for a predetermined time period and then turn the water heaters 311 to 313 and the heat pump 150 off. Such the on-off process may be executed at regular cycles.

Thereafter, the actual heating power consumption may be compared with the optimal use power consumption to determine the maximum savable power consumption when the vehicle actually travels (S450).

Thereafter, the management server 280 may be configured to generate the maximum savable power consumption as energy efficiency information and feedbacks the energy efficiency information back to the corresponding vehicle (S460).

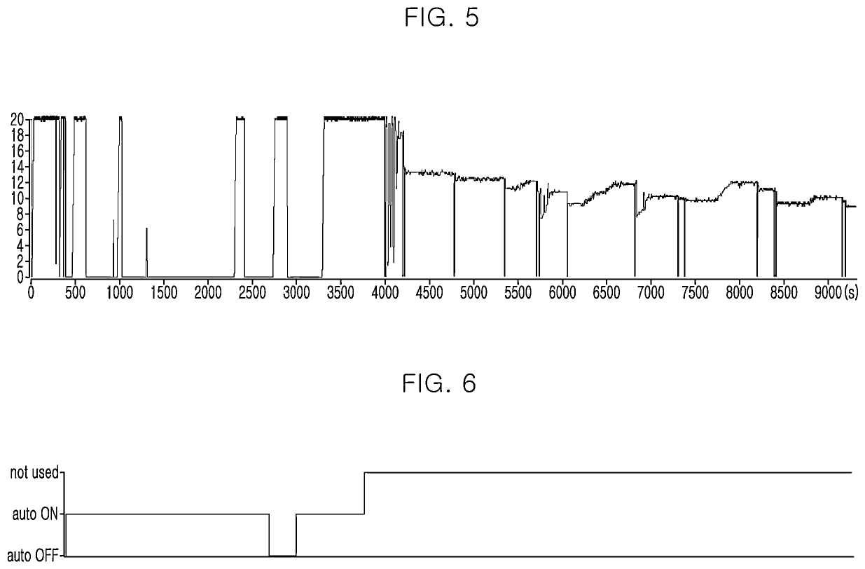

FIG. 5 is a graph showing a concept in which power consumption of a water heater is determined according to an exemplary embodiment of the present disclosure. Referring to FIG. 5, when the in-vehicle communication message is transmitted from the control unit 110 of the vehicle 30 to the management server 280, the controller 282 of the management server 280 may obtain the graph shown in FIG. 5 from the in-vehicle communication message. The x-axis may indicate a time (unit: seconds), and the y-axis may indicate power consumption. Therefore, in the graph shown in FIG. 5, an area of the portion forming the quadrangular shape may be the power consumption (unit: kWh) of the water heater. It is mathematically expressed by expression, y[Kw] *x[s]*3600.

Meanwhile, the heat pump power consumption may be determined in a similar manner.

Therefore, an actual heating power consumption Xᵣₑₐₗ may be the sum of the power amount of the water heater and the power amount of the heat pump. Expressing it mathematically, the actual heating power consumption Xᵣₑₐₗ=water heater power consumption+heat pump power consumption. The actual heating power consumption Xᵣₑₐₗ may indicate an actual power use value.

FIG. 6 is a graph showing a concept in which an auto duty ratio is determined according to an exemplary embodiment of the present disclosure. Referring to FIG. 6, an auto duty ratio may be required to determine optimal use power consumption indicating a predicted power consumption value.

In other words, the optimal use power consumption may be determined by applying a correction constant Cₜₑₘₚ for power consumption conversion when the manual mode according to an average outside air temperature for actual days of use, which is stored at the storage unit 240, is changed to the auto mode and an auto duty ratio indicating an operation ratio of the auto mode upon actual heating operation to the actual use heating power Xᵣₑₐₗ determined above. The correction constant Cₜₑₘₚ may be a value preset through experiment.

In other words, optimal use power consumption Yₒₚₜ may be determined by summing a first value determined by multiplying the actual use heating power Xᵣₑₐₗ by the correction constant Cₜₑₘₚ and a second value obtained by multiplying a value, which may be obtained by multiplying the actual use heating power Xᵣₑₐₗ by the actual use heating power Xᵣₑₐₗ and the correction constant Cₜₑₘₚ, by the auto duty ratio.

It is expressed by an equation as follows.

$$Optimal use power consumption {Y}_{opt} = actual heating power consumption {X}_{real} \times correction constant {C}_{temp} + ( {X}_{real} - {C}_{temp} \times {X}_{real} ) \times auto duty ratio \qquad [ Equation 1 ]$$

Here, the auto duty ratio may indicate the auto operation duty ratio during actual heating operation. Expressing it as an equation, auto duty ratio=auto mode operation time/(auto mode operation time+manual mode operation time).

The auto mode may indicate a method in which the heater is automatically turned on or off according to a preset algorithm, and the manual mode indicates a method in which the auto mode is not used and the driver turns the heater on or off by directly selecting the button.

Referring to FIG. 6, the x-axis indicates a time (unit: seconds), and the y-axis indicates a value. It is summarized by a table as follows.

TABLE 1

| Value | type | description |
|---|---|---|
| 0x0 | auto OFF | heater OFF |
| 0x1 | auto on | heater auto mode |
| 0x2 | not used (manual ON) | heater manual mode |
| 0x3 | invalid | heater pump use prohibition mode |

Therefore, the auto mode operation time may be a time for which 0x1 (auto ON) value is input and maintained in a waveform, and the manual mode operation time may be a time for which a 0x2 (not used) value is input and maintained.

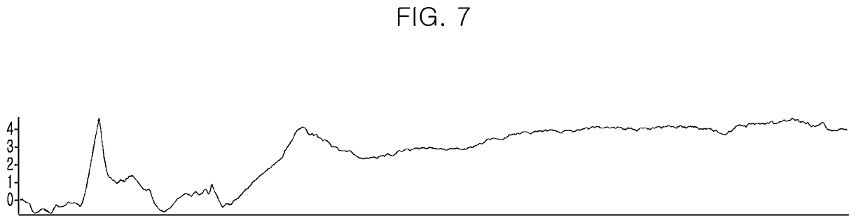

FIG. 7 is a graph showing a concept in which an average outside temperature is determined according to an exemplary embodiment of the present disclosure. Referring to FIG. 7, the average outside air temperature for the actual days of use may be determined using a graph extracted from the in-vehicle communication message transmitted from the control unit 110 of the vehicle 30 as shown in FIG. 7. Referring to FIG. 7, the x-axis indicates a date, and the y-axis indicates a temperature.

The correction constant may be a correction constant for power consumption conversion when the manual mode is changed to the auto mode according to the average outside air temperature. For example, when the outside air temperature is −10° C. and the power consumption in the manual mode is 10 kWh, the power consumption may be changed to 8 kWh in the auto mode by multiplying the power consumption by the correction constant (e.g., 0.8). Of course, the correction constant according to the outside air temperature may be configured in advance as a lookup table.

Furthermore, a value of the correction constant may be determined by comparing the manual mode with the auto mode under the same conditional situation using evaluation result values of an actual vehicle. The evaluation result values may be values obtained in advance through a wind tunnel experiment or the like.

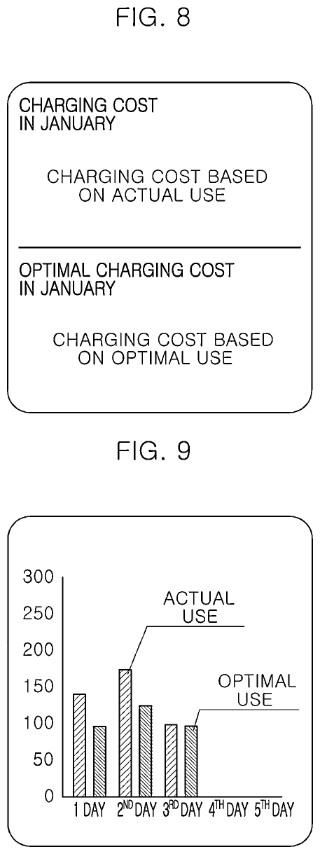

FIG. 8 is an example of a display screen on which a charging cost by month of the vehicle is displayed according to an exemplary embodiment of the present disclosure. Referring to FIG. 8, a charging cost based on the actual heating use power consumption (i.e., the sum of charging costs per day) indicates actual heating power consumption (Xᵣₑₐₗ)_1 day× [symbol] /1 kWh+actual heating power consumption (Xᵣₑₐₗ)_2 days× [symbol] /1 kWh+ . . . , where [symbol] denotes Korean currency (Won).

Meanwhile, the charging cost (i.e., the sum of optimal charging costs per day) based on the optimal use power consumption may be optimal use power consumption (Yₒₚₜ)_1 day× [symbol] /1 kWh+optimal use power consumption (Yₒₚₜ)_2 days× [symbol] /kWh+ . . . .

W/1 kWh may reflect the actual charging cost of each transportation company.

FIG. 9 is an example of a screen on which heating power consumption per day of the vehicle is displayed according to an exemplary embodiment of the present disclosure. Referring to FIG. 9, the actual heating power consumption and the optimal use heating power consumption may be displayed in a form of a bar graph. In the instant case, the bar graph may be of different colors for easy identification. of course, although only the bar graph is displayed in FIG. 9, a value obtained by subtracting the optimal use power consumption from the actual heating power consumption may also be displayed. It indicates the maximum savable power consumption.

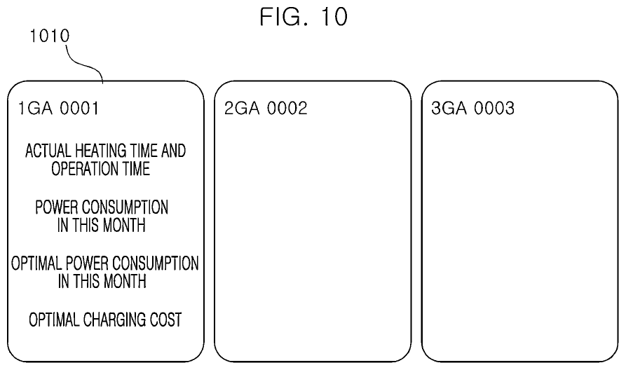

FIG. 10 is an example of a screen on which simplified vendor management vehicle information is displayed according to an exemplary embodiment of the present disclosure. Referring to FIG. 10, it is an example in which simple information 1010 is displayed on vehicles managed by each transportation company. The simple information may display an actual heating operation time, actual/optimal power consumption by month, an optimal charging cost, and the like. of course, the simple information may be displayed for each vehicle.

FIG. 8 and FIG. 9 show graphical expression, but audio output is also possible. of course, a combination of text, voice, and graphics is also possible.

The method of providing the heating power information of the vehicle to the driver may be implemented in a form of program commands which may be performed through various computer devices and recorded on a computer-readable medium. The computer-readable medium may include program commands, data files, data structures, and the like alone or in combination. In the instant case, various computer devices may be implemented as an application specific integrated circuit (ASIC), digital signal processing (DSP), a programmable logic device (PLD), a field programmable gate array (FPGA), a processor, a controller, a microprocessor, other electronic units, or a combination thereof.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

Hereinafter, the fact that pieces of hardware are coupled operably may include the fact that a direct and/or indirect connection between the pieces of hardware is established by wired and/or wirelessly.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method of providing heating power information to a driver of a vehicle, the method comprising:
executing, by a control unit of the vehicle, a heating mode to operate a water heater for indoor heating according to a driver's input command;
collecting, by the control unit, power consumption-related information according to the heating mode;
transmitting, by the control unit, the power consumption-related information to a management server communicatively connected to the control unit; and
generating, by the management server, energy efficiency information indicating maximum savable power consumption using the power consumption-related information and feedbacking the energy efficiency information to the control unit of the vehicle.

2. The method of claim 1, wherein the maximum savable power consumption is a result of comparison between actual heating power consumption consumed while the vehicle travels actually and optimal use power consumption indicating a predicted power consumption value.

3. The method of claim 2, wherein the optimal use power consumption is determined only in case of using an auto mode in which at least one of one or more water heaters disposed on an internal floor of the vehicle and a heat pump disposed on a roof of the vehicle is automatically turned on or off according to a preset algorithm.

4. The method of claim 3, wherein the power consumption-related information includes actual heating power consumption indicating an actual power use value according to the heating mode, information indicating ON/OFF of the auto mode, and information indicating a manual mode in which the auto mode is not used.

5. The method of claim 4, wherein the optimal use power consumption is determined by applying a correction constant for power consumption conversion in response that the manual mode according to an average outside air temperature for actual days of use is changed to the auto mode and an auto duty ratio indicating an operation ratio of the auto mode upon actual heating operation to an actual use heating power.

6. The method of claim 5, wherein the optimal use power consumption is determined by summing a first value determined by multiplying the actual use heating power by the correction constant and a second value obtained by multiplying a value, which is obtained by multiplying the actual use heating power and the correction constant by the auto duty ratio, by the actual use heating power.

7. The method of claim 5, wherein the auto duty ratio is a value obtained by dividing an auto mode operation time by a sum of the auto mode operation time indicating an operation time of the auto mode and a manual mode operation time indicating an operation time of the manual mode.

8. The method of claim 7, wherein the auto mode operation time and the manual mode operation time are each determined using a time for which a predetermined value is input and maintained in a waveform extracted from the power consumption-related information.

9. The method of claim 3, wherein the actual heating power consumption is determined using an area of a quadrangle formed between an x-axis indicating a time and a y-axis indicating power consumption in a graph extracted from the power consumption-related information.

10. The method of claim 9, wherein the actual heating power consumption is a sum of a power consumption of a water heater determined by an area of the quadrangle and the power consumption of the heat pump.

11. The method of claim 3, wherein, in response that operation buttons configured for operating the one or more water heaters and the heat pump provided in the vehicle are connected, the heat pump is operated by being connected automatically in response that the one or more water heaters are operated in the heating mode.

12. The method of claim 1, wherein the power consumption-related information is a form of an in-vehicle communication message.

13. The method of claim 1, wherein the feedbacking includes outputting the energy efficiency information on a display unit in combination of texts, voices, and graphics.

14. A method of providing heating power information to a driver of a vehicle, the method comprising:
executing, by a control unit of the vehicle, a heating mode to operate a water heater for indoor heating according to a driver's input command;
collecting, by the control unit, power consumption-related information according to the heating mode;
transmitting, by the control unit, the power consumption-related information to a management server communicatively connected to the control unit; and
generating, by the management server, energy efficiency information indicating a maximum savable power consumption using the power consumption-related information and feedbacking the energy efficiency information to the control unit of the vehicle,
wherein the executing of the heating mode includes, in a state that operation buttons configured for operating one or more water heaters and a heat pump provided in the vehicle are configured separately, providing, by the control unit, a guidance message which allows the heat pump to operate together in response that the one or more water heaters is operated in the heating mode.

15. A system of providing heating power information to a driver of a vehicle, the system comprising:
a heating system including:
a control unit for controlling a heating mode to operate a water heater block,
the water heater block for heating a passenger compartment of the vehicle,
a main driving unit operatively connected to the water heater block for operating the water heater block,
a heat pump mounted on a roof of the vehicle,
a pump driving unit operatively connected to the heat pump for operating the heat pump, and
an air conditioner for controlling temperature, humidity and cleanliness of air in the passenger compartment of the vehicle,
wherein the control unit operatively connected to the main driving unit, the pump driving unit and the air conditioner is configured to:
execute the heating mode according to a driver's input command;
collect power consumption-related information according to the heating mode;
transmit the power consumption-related information to a management server communicatively connected to the control unit; and
generate, by the management server, energy efficiency information indicating maximum savable power consumption using the power consumption-related information and feedbacking the energy efficiency information to the control unit of the vehicle.

16. The system of claim 15,
wherein the maximum savable power consumption is determined based on optimal use power consumption indicating a predicted power consumption value, and
wherein the optimal use power consumption is determined only in case of using an auto mode in which at least one of one or more water heaters disposed on an internal floor of the vehicle and a heat pump disposed on a roof of the vehicle is automatically turned on or off according to a preset algorithm.

17. The system of claim 16, wherein the power consumption-related information includes actual heating power consumption indicating an actual power use value according to the heating mode, information indicating ON/OFF of the auto mode, and information indicating a manual mode in which the auto mode is not used.

18. The system of claim 17, wherein the optimal use power consumption is determined by applying a correction constant for power consumption conversion in response that the manual mode according to an average outside air temperature for actual days of use is changed to the auto mode and an auto duty ratio indicating an operation ratio of the auto mode upon actual heating operation to an actual use heating power.

19. The system of claim 18, wherein the optimal use power consumption is determined by summing a first value determined by multiplying the actual use heating power by the correction constant and a second value obtained by multiplying a value, which is obtained by multiplying the actual use heating power and the correction constant by the auto duty ratio, by the actual use heating power.

20. The system of claim 17, wherein the actual heating power consumption is determined using an area of a quadrangle formed on an x-axis indicating a time and a y-axis indicating power consumption in a graph extracted from the power consumption-related information.
